(19) United States
(12) Patent Application Publication
(10) Pub. No.: US 2016/0089692 A1
(43) Pub. Date: Mar. 31, 2016

(54) TURBINE COMPONENT COATING PROCESSES AND TURBINE COMPONENTS

(71) Applicant: General Electric Company, Schenectady, NY (US)

(72) Inventors: Thomas Robert Reid, Greenville, SC (US); Jonathan Matthew Lomas, Simpsonville, SC (US)

(73) Assignee: General Electric Company

(21) Appl. No.: 14/501,607

(22) Filed: Sep. 30, 2014

(51) Int. Cl. B05D 1/32; B05D 1/28; B05D 3/12; F01D 25/00; B05D 5/00; C23C 4/12; C23C 28/00; F01D 5/28; B05D 1/36; B05D 7/14

(52) U.S. Cl. CPC B05D 1/322; B05D 1/36; B05D 1/28; B05D 3/12; B05D 7/14; B05D 5/00; C23C 4/124; C23C 4/127; C23C 28/00; F01D 5/288; F01D 25/007; F05D 2230/90; F05D 2260/231

(57) ABSTRACT

Turbine component coating processes include applying a malleable masking material to one or more apertures of one or more fluid flow passages within a turbine component surface and then applying a first coating over the malleable masking material and on the turbine component surface. The turbine component coating processes further include locally applying a local masking material to the one or more apertures of the one or more fluid flow passages and then applying a second coating over the local masking material and on the first coating.

### FIELD OF THE INVENTION

The present invention is directed toward a turbine component coating process and a turbine component. More specifically, the present invention is directed to masking for a turbine component coating process including multiple maskants and coatings, and a turbine component including multiple coatings.

### BACKGROUND OF THE INVENTION

Turbine components are often run at high temperatures to provide maximum operating efficiency. However, the temperature at which a turbine can run may be limited by the temperature capabilities of the individual turbine components. In order to increase the temperature capabilities of turbine components, various methods have been developed. One method for increasing the temperature capabilities of a turbine component includes the incorporation of internal cooling holes, through which cool air is forced during turbine engine operation. As cooling air is fed from the cooler side of the component wall through a cooling hole outlet on the hot side, the rushing air assists in lowering the temperature of the hot metal surface.

Another technique for increasing the temperature capabilities of a turbine component includes the application of coatings, such as a bond coat and a thermal barrier coating (TBC). Often, turbine components include both cooling holes and various coatings applied over the surface of the component. Typically, when cooling holes are formed or modified (e.g., repaired) in the component prior to the (re)application of the coatings, the cooling holes are either masked before coating or the coating is removed from the cooling holes after application. Current masking methods are often limited to applying a single masking material, then applying the one or more coatings to the component. The multiple coating applications may diminish the masking material, particularly when multiple application techniques are used, and thus may decrease the effectiveness of the masking process.

A turbine component coating process with improvements would be desirable in the art.

### BRIEF DESCRIPTION OF THE INVENTION

In one embodiment, a turbine component coating process is disclosed. The turbine component coating process includes applying a malleable masking material to one or more apertures of one or more fluid flow passages within a turbine component surface and then applying a first coating over the malleable masking material and on the turbine component surface. The turbine component coating process further includes locally applying a local masking material to the one or more apertures of the one or more fluid flow passages and then applying a second coating over the local masking material and on the first coating.

In another embodiment, a turbine component coating process is disclosed. The turbine component coating process includes applying a malleable masking material to one or more apertures of one or more fluid flow passages within a turbine component surface, wherein at least a portion of the malleable masking material is pushed into the one or more apertures below the turbine component surface and then applying a first coating over the masking material and on the turbine component surface, wherein the portion of malleable masking material pushed into the one or more apertures causes at least a portion of the first coating to form a step on a floor of the one or more apertures. The turbine component coating process further includes locally applying a local masking material to the one or more apertures and then applying a second coating over the local masking material and on the first coating.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a turbine component according to an embodiment of the disclosure.

FIG. 2 is a flow diagram of a turbine component coating process.

FIG. 3 is a schematic view of a turbine component coating process.

FIG. 4 is cross sectional view of a fluid flow passage and aperture of a turbine component.

FIG. 5 is an overhead view of the turbine component of FIG. 4.

Wherever possible, the same reference numbers will be used throughout the drawings to represent the same parts.

### DETAILED DESCRIPTION OF THE INVENTION

Provided are a turbine component coating process and a turbine component. Embodiments of the present disclosure, in comparison to articles and methods not using one or more of the features disclosed herein, increase aperture complexity, increase masking efficiency, increase masking effectiveness, increase masking specificity, decreases coating build-up in apertures, increases visibility for automated hole location, decreases volume of residual coating left after post process cooling hole clearing, decreases post-process hole clearing difficulty, or a combination thereof

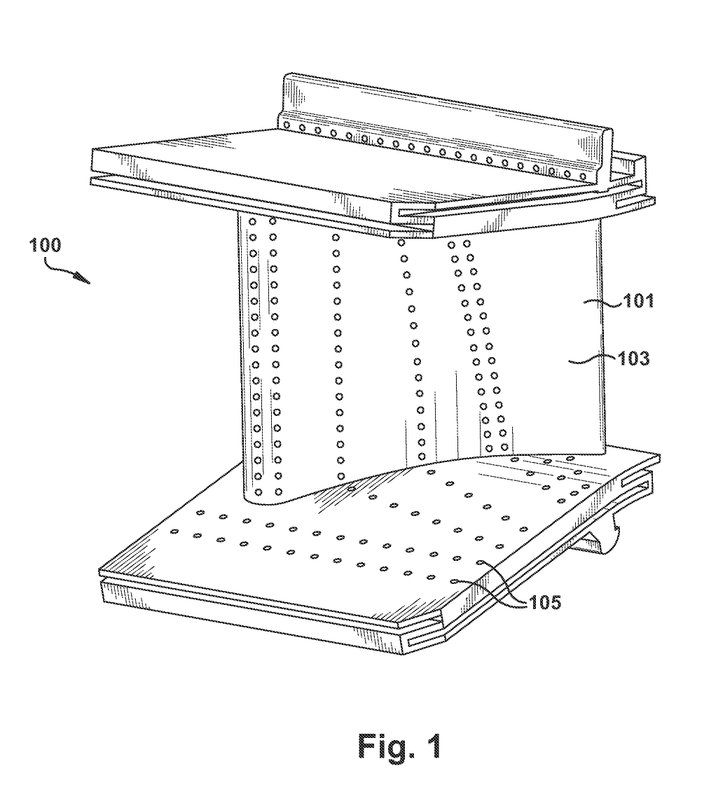

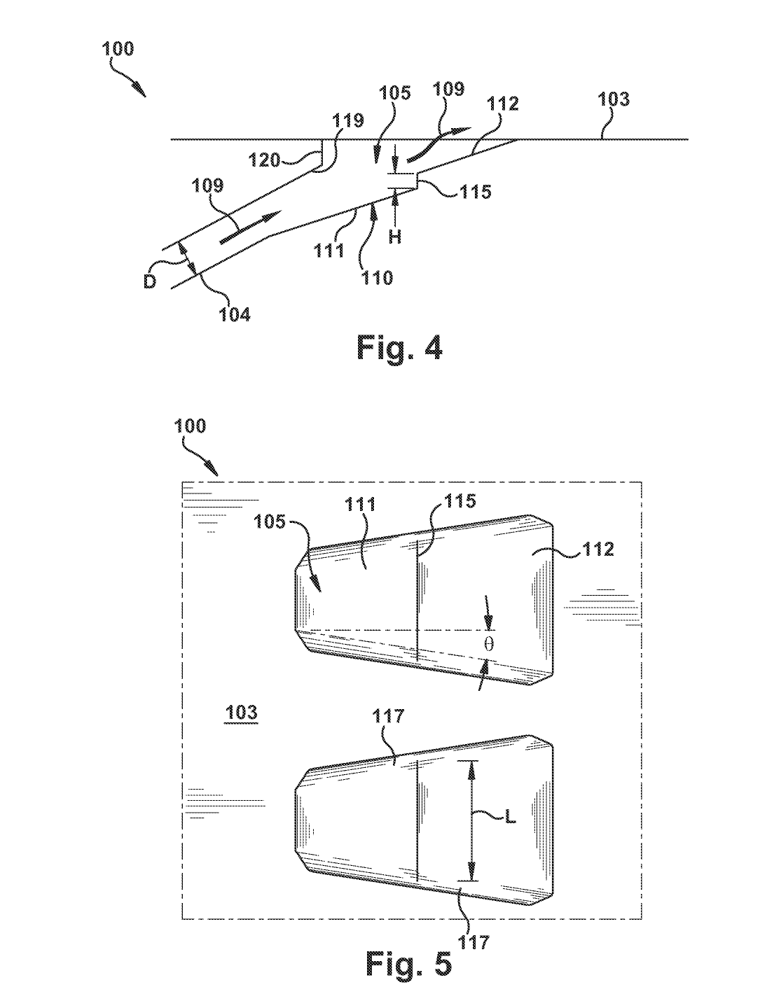

As illustrated in FIG. 1, in one embodiment, a component 100 includes a substrate 101 having a surface 103 with at least one aperture 105 fluidly connected to at least one fluid flow passage 104. In some embodiments, such as when the component 100 comprise a turbine component, the at least one aperture 105 may comprise a cooling hole and the at least one fluid flow passage 104 may comprise a cooling channel. Each of the fluid flow passages 104 and apertures 105 may comprise a cross-sectional geometry, wherein the cross-sectional geometry may include a constant cross-sectional geometry, a varied cross-sectional geometry, a diffuser cross-sectional geometry, a cylindrical cross-sectional geometry, a non-cylindrical cross sectional geometry, an oval cross-sectional geometry, a chevron geometry, a converging geometry, a diverging geometry, and/or any other suitable geometry, or combinations thereof. The fluid flow passages 104 and apertures 105 may further comprise a variety of other variable configurations. For example, the apertures 105 and fluid flow passages 104 may be formed with centerlines that enter the surface 103 at varying radial angles such as from about 5° to about 175° and axial angles to the surface 103 of from about 5° to about 90°. In some embodiments, such centerlines may be at compound angles including both radial and axial angles. Moreover, the fluid flow passages 104 and apertures 105 may comprise floors (element 110 in FIG. 4) that are planar, contoured or combinations thereof.

Suitable components 100 for the disclosed embodiments include, for example, blades or buckets; shrouds; nozzles; vanes; transition pieces; liners; combustors; transition pieces; other components having apertures, such as cooling holes; or combinations thereof. The turbine components 100 may be fabricated from high temperature oxidation and corrosion resistant materials, including, for example, nickel-based superalloys, cobalt-based superalloys, gamma prime superalloys, stainless steels, or combinations thereof. In some embodiments, the turbine nozzle, or other turbine component, may include a coating applied over the surface 103. The coating may be a single layer, more than one layer, or a plurality of layers. Suitable coatings can include, but are not limited to, a bond coat, a thermal barrier coating (TBC), an environmental barrier coating (EBC), or combinations thereof.

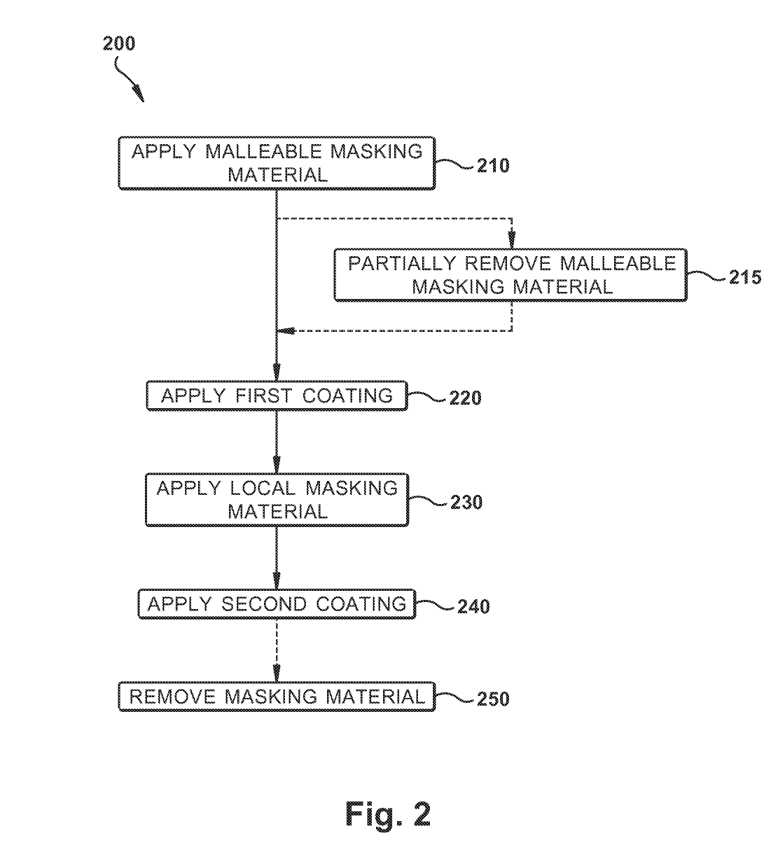

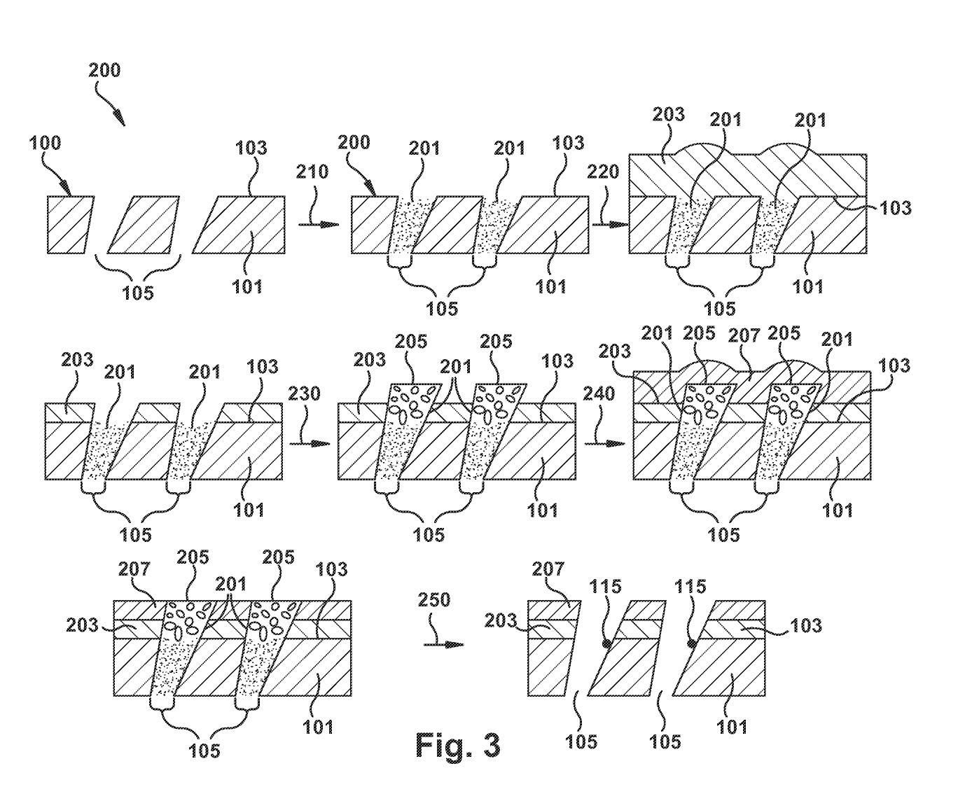

Referring to FIGS. 2-3, a turbine component coating process 200 first generally comprises applying a malleable masking material 201 to one or more apertures 105 (e.g., cooling holes) of fluid flow passages 104 (e.g., cooling channels) within the surface 103 of the turbine component 100 in step 210. In some embodiments, a portion of the malleable masking material 201 may be removed in step 215. The turbine component coating process 200 then generally comprises applying a first coating 203 over the malleable masking material 201 and on the turbine component surface 103 in step 220. The malleable masking material 201 at least partially covers the at least one aperture 105 to decrease or eliminate deposition of the first coating 203 in the at least one aperture 105. After applying the first coating 203 in step 220, the turbine component coating process 200 generally includes locally applying a local masking material 205 to the one or more apertures 105 in step 230, and then applying a second coating 207 over the local masking material 205 and on the first coating 203 in step 240. Any remaining maskants may then optionally be removed in step 250. The local application of the local masking material 205 in step 230 may decrease or eliminate exposure of the first coating 203, or any other existing coating, to grit blasting during non-local maskant application. Additional masking materials and coatings may be subsequently applied to form a desired coating composition and/or thickness over the surface 103 of the component 100.

Specifically, the combination of the malleable masking material 201 and the local masking material 205 may decrease or eliminate deposition of the first and/or second coating 203 and 207 and/or any additional coatings in the one or more apertures 105, while further facilitating a less labor intensive process by allowing for broad masking applications where possible. Furthermore, in some embodiments, the malleable masking material 201 may facilitate a limited deposition of coating material 203 and 207 within the aperture 105 to form a step 115 to disrupt fluid flow 109 exiting the fluid flow passage 104 (illustrated in FIGS. 4 and 5). As should become appreciated herein, such disruption may promote airflow along the surface 103 of the turbine component 100 without premature separation to increase the cooling effect on the turbine component 100. The individual turbine component coating process steps, masking materials and coating materials will now be discussed in more detail.

Still referring to FIGS. 2 and 3, the malleable masking material 201 applied in step 210 can comprise any malleable material that is suitable for entering the one or more apertures 105 when force is applied from the surface 103 while further inhibiting or preventing bonding with the subsequent first coating 203. As should become better appreciated herein, the malleable nature of the malleable masking material 201 may at least facilitate a broad application of the first masking step to promote a less labor intensive process. Moreover, in even some embodiments, the malleable nature of the malleable masking material 201 may become at least slightly depressed within the one or more apertures 105 as a result of removing the broad application of the malleable masking material 201 (e.g., via grit blasting) and/or applying the first coating 203 (e.g., via HVOF). Such depression of the malleable masking material 201 within the one or more apertures 105 may facilitate the limited deposition of coating material 203 and 207 within the aperture 105 to form a step 115 to disrupt fluid flow 109 exiting the fluid flow passage 104 (illustrated in FIGS. 4 and 5).

In some embodiments, the malleable masking material 201 is therefore selected based upon a composition and/or the application method of the first coating 203. In some embodiments, the malleable masking material 201 is selected to control the diminishment of the maskant throughout application of a subsequent coating layer. As used herein, “diminishment” refers to decreasing a level of the maskant with respect to the surface 103, such as through degrading, removing, shrinking, and/or recessing the maskant within the aperture 105. In even some embodiments, the malleable masking material 201 is selected based upon a method of application of the maskant to decrease or eliminate contamination and/or damage (e.g., chipping during excess maskant removal) of an applied coating.

Suitable materials for the malleable masking material 201 can include, but are not limited to, a silicone elastomer, an epoxy, a ductile material, or combinations thereof. In some particular embodiments, the malleable masking material 201 includes a material having ductile properties that provide resistance (i.e., decrease or eliminate diminishment from) to the HVOF spray process, such as the silicone elastomer. In some embodiments, the silicone elastomer can include any elastomer suitable for resisting grit blasting and/or high velocity particles. One such exemplary suitable silicone elastomer is commercially available as MachBloc and comprises a ductile (e.g., rubbery, putty-like) material having a medium temperature melting point/boiling point and a composition of, by weight, between about 20% and about 30% methyl vinyl/di-methyl vinyl/vinyl terminated siloxane, between about 20% and about 30% vinyl silicone fluid, between about 15% and about 30% ground silica, between about 15% and about 25% silicon dioxide, between about 3% and about 9% silanol terminated PDMS, up to about 0.5% sodium alumino sulphosilicate, up to about 1% vinyl-tris(2-methoxy ehoxy)silane, up to about 1% titanium dioxide, up to about 2% precipitated silica, up to about 1% stoddard solvent, up to about 0.5% neodecanoic acid, rare earth salts, up to about 0.5% rare earth 2-ethylhexanoate, and up to about 0.2% magnesium ferrite.

The malleable masking material 201 may be applied to the component 100 in step 210 in any amount and/or thickness sufficient to at least partially cover at least one aperture 105. For example, the malleable masking material 201 may be slightly below level with, level with, substantially level with, or form a protrusion extending above, the surface 103. In one embodiment, the malleable masking material 201 is applied to the surface 103 to a broad area of the turbine component surface 103 that comprises one or more apertures 105 of fluid flow passages 104. For example, the malleable masking material 201 may be applied via a roller application over a broad surface area.

In some embodiments, the malleable masking material 201 is removed from the surface 103 in step 215 prior to the applying of the first coating 203 in step 220. Such removal can re-expose the surface 103 of the turbine component 100 while leaving the one or more apertures 105 masked. For example, in some embodiments, removal may be performed by grit blasting or the like. As discussed above, such embodiments may actually push the malleable masking material 201 further into the aperture 105 such that it sits below the surface 103 of the component 100. It should be noted that in a further embodiment, the applying of the first coating 203 in step 220 may alternatively or additionally recesses the malleable masking material 201 into the one or more apertures 105.

However, in some embodiments, removal may result in masked apertures wherein the malleable masking material is substantially level with, or even protruding from, the surface 103 of the component 100. In even some embodiments, the malleable masking material 201 may be applied only to the one or more apertures 105, reducing or eliminating deposition and/or subsequent removal of the malleable masking material 201 from the surface 103.

Still referring to FIGS. 2 and 3, the first coating 203 applied in step 220 can comprise any suitable coating and any suitable application method that facilitates adhesion (e.g., chemical/mechanical bonding or the like) on the surface 103 of the turbine component 100 without significant adhesion on the malleable masking material 201 itself For example, in some embodiments, the first coating 203 may comprise a thermal spray coating, an oxidation protection coating, a metallic coating, a bond coating, an overlay coating, or any other type of coating such as those that may be used for a bond coat, thermal barrier coating (TBC), environmental barrier coating (EBC), or combinations thereof In some exemplary embodiments, the first coating 203 comprises the bond coat applied by the HVOF spray application method. Such embodiments may be particularly suitable for when the second coating 207 is scheduled to comprise bond coat or TBC applied by the APS application method. For example, in some particular embodiments, a first coating may comprise bond coat applied by HVOF, a second coating may comprise bond coat applied by APS, and a third coating may comprise TBC (e.g., DVC TBC) applied by APS.

In some particular embodiments, the first coating 203 may be applied through any kinetic energy process (e.g., HVOF). The force of the first coating 203 striking the malleable masking material 201 through the kinetic energy process may start or continue to depress the malleable masking material 201 within at least one of the one or more apertures 105 such that the malleable masking material 201 sits below the surface 103 of the component 100. In other embodiments, the first coating 203 may be applied through any other suitable process such as thermal spray, air plasma spray (APS), high velocity air fuel spraying (HVAF), vacuum plasma spray (VPS), electron-beam physical vapor deposition (EBPVD), chemical vapor deposition (CVD), ion plasma deposition (IPD), combustion spraying with powder or rod, cold spray, sol gel, electrophoretic deposition, tape casting, polymer derived ceramic coating, slurry coating, dip-application, vacuum-coating application, curtain-coating application, brush-application, roll-coat application, agglomeration and sintering followed by spray drying, or a combination thereof.

As discussed above, in some embodiments, the malleable masking material 201 may cause at least a portion of the first coating 203 to form a step (element 115 in FIGS. 4 and 5) in at least one of the one or more apertures 105 of the one or more fluid flow passages 104. Such embodiments may occur when the malleable masking material 201 is depressed below the level of the surface 103 such that a portion of the first coating 203 partially enters the aperture 105.

Still referring to FIGS. 2 and 3, the local masking material 205 applied in step 230 can comprise any material that is suitable for local application to the one or more apertures 105 while further inhibiting or preventing bonding with the subsequent second coating 207. The local application in step 230 of the local masking material 205 may limit or avoid any removal of additional masking material on top of the first coating 203 so as to limit or avoid any collateral damage to the first coating 203.

The local masking material 205 can comprise any material that is suitable for local application on or within the one or more apertures 105 while further inhibiting or preventing bonding with the subsequent first coating 203. In some embodiments, the local masking material 205 is there selected based upon a composition and/or the application method of the second coating 207. In some embodiments, the local masking material 205 is selected to decrease or eliminate diminishment of the maskant throughout application of a subsequent coating layer. As used herein, “diminishment” refers to decreasing a level of the maskant with respect to the surface 103, such as through degrading, removing, shrinking, and/or recessing the maskant within the aperture 105. In even some embodiments, the local masking material 205 is selected based upon a method of application of the maskant to decrease or eliminate contamination and/or damage (e.g., chipping during excess maskant removal) of an applied coating.

Suitable materials for the local masking material 205 can include, but are not limited to an ultraviolet (UV)-curable material, an electron beam (EB)-curable material, an epoxy, a brittle material, or combinations thereof. In some embodiments, the local masking material 205 includes a material having brittle properties that provide resistance to high temperatures present in the APS process, such as the UV-curable material. In some embodiments, the UV-curable material and/or the EB-curable material includes any material suitable for flowing through a syringe and/or resisting high temperatures of, for example, at least 500° F., at least 600° F., at least 700° F., at least 800° F., between 500° F. and 800° F., or any combination, sub-combination, range, or sub-range thereof. In a further embodiment, the UV-curable material may be devoid or substantially devoid of thermal-curing properties at a select temperature, for example, of up to 800° F. One such suitable material is a high temperature melting point/boiling point epoxy, such as, but not limited to, acrylated urethane. The high temperature melting point/boiling point includes, for example, a temperature of at least 1,200° F., at which the epoxy is incinerated.

The local masking material 205 may be locally applied to the one or more apertures 105 in step 230 in any amount and/or thickness sufficient to cover the malleable masking material 201 and/or any unmasked portions of the at least one aperture 105. In some embodiments, the local masking material 205 is locally applied over the malleable masking material 201 and/or in portions of the at least one aperture 105 exposed by the recessing of the malleable masking material 201. In some embodiments, the malleable masking material 201 is removed from the at least one aperture 105 prior to the local applying of the local masking material 205 in step 230. The local masking material 205 may be slightly below level with, level with, substantially level with, or form a protrusion extending above, the surface 103 and/or the first coating 203. Suitable methods of application of the local masking material 205 include manual application with a syringe, automated application with a syringe, using a paint-brush, using a finger, extruding the local masking material 205 through the at least one aperture 105 from a region distal from the surface 103, or combinations thereof.

Still referring to FIGS. 2 and 3, the second coating 207 applied in step 240 can comprise any suitable coating and any suitable application method that facilitates adhesion (e.g., chemical/mechanical bonding or the like) onto the first coating 203 that was previously applied onto the surface 103 of the turbine component 100 without significant adhesion on the local masking material 205 itself. For example, in some embodiments, the second coating 207 may comprise a thermal spray coating, an oxidation protection coating, a metallic coating, a bond coating, an overlay coating, or any other type of coating such as those that may be used for a bond coat, thermal barrier coating (TBC), environmental barrier coating (EBC), or combinations thereof. In some exemplary embodiments, the second coating 207 comprises the bond coat and/or thermal barrier coating applied by the APS application method. Such embodiments may be particularly suitable for when the first coating 203 comprises bond coat applied by the HVOF spray application method.

The second coating 207, and/or any additional coatings may be applied by any suitable application method. Suitable application methods include, but are not limited to, thermal spray, air plasma spray (APS), high velocity oxygen fuel (HVOF) thermal spray, high velocity air fuel spraying (HVAF), vacuum plasma spray (VPS), electron-beam physical vapor deposition (EBPVD), chemical vapor deposition (CVD), ion plasma deposition (IPD), combustion spraying with powder or rod, cold spray, sol gel, electrophoretic deposition, tape casting, polymer derived ceramic coating, slurry coating, dip-application, vacuum-coating application, curtain-coating application, brush-application, roll-coat application, agglomeration and sintering followed by spray drying, or combinations thereof. In one example, the second coating 207 includes the bond coat and/or thermal barrier coating applied by the APS as discussed above.

After applying the second coating 207 and/or any other additional coatings, the local masking material 205 (and any remaining malleable masking material 201) may optionally be removed in step 250. In some embodiments, the malleable masking material 201 and/or the local masking material 205 can be removed by a heating operation such that the masking materials melt away from the turbine component. In some embodiments, the malleable masking material 201 and/or the local masking material 205 can be removed by water jet, manual clearing, or combinations thereof.

In some embodiments, the local masking material 205 decreases adhesion of the second coating 207, providing effective cleaning of the at least one aperture 105 through water jet or manual clearing. In some embodiments, removing the local masking material 205 includes exposing the local masking material 205 to a temperature above the boiling temperature for the local masking material 205. In some embodiments, the exposing of the local masking material 205 to a temperature above the boiling temperature melts the local masking material 205, causing the local masking material 205 to run out through the at least one aperture 105. Exposing the local masking material 205 to a temperature above the boiling temperature (i.e., a heating operation) includes, for example, positioning the component 100 in a furnace, placing the component 100 in operation under operating temperatures that exceed the boiling temperature, or locally heating the local masking material 205 (e.g., focused laser beam).

In even some embodiments, the turbine component coating process 200 includes removing an existing coating from the surface 103 of the component 100 prior to the applying of the malleable masking material 201 (step 210). The existing coating includes any existing coating, such as, but not limited to, an operationally-used coating, a damaged coating, or a defective coating. For example, the coating process 200 may include removing the operationally-used coating to replace the existing coating with a new coating, to repair the component 100, to inspect the component 100, during maintenance of the component 100, or a combination thereof. In one embodiment, at least a portion of the existing coating is removed manually, with a chemical solution, or a combination thereof.

Referring now to FIGS. 4 and 5, a turbine component 100 is illustrated comprising at least one fluid flow passage 104 and at least one aperture 105 disposed on the surface 103 of the turbine component 100 and fluidly connected to the at least one fluid flow passage 104. As discussed above, the turbine component 100 can comprise, for example, blades or buckets; shrouds; nozzles; vanes; transition pieces; liners; other components having apertures, such as cooling holes; or combinations thereof. The turbine components 100 may be fabricated from high temperature oxidation and corrosion resistant materials, including, for example, nickel-based superalloys, cobalt-based superalloys, gamma prime superalloys, stainless steels, or combinations thereof.

The aperture 105 (e.g., cooling hole) can further comprise a variety of configurations. For example, the aperture 105 may comprise a cross-sectional geometry, wherein the cross-sectional geometry may include a constant cross-sectional geometry, a varied cross-sectional geometry, a diffuser cross-sectional geometry (as illustrated in FIG. 5), a circular cross-sectional geometry, an oval cross-sectional geometry, a chevron geometry, a converging geometry, a diverging geometry, and/or any other suitable geometry, or combinations thereof.

The at least one aperture 105 may generally comprise a floor 110 for which guides the bottom of the fluid flow 109 as it exits the component 100. Depending on the specific configuration of the fluid flow passage 104 and aperture 105, one or more side walls 117 and/or a ceiling 119 may further bound the exiting fluid flow 109. In even some embodiments, the ceiling 119 and or the side walls 117 may comprise a taper 120 towards the surface 103. In such embodiments, the taper comprise a height of from about 0.0 inches (e.g., a sharp edge) to about 0.045 inches or greater depending, for example, on the manufacturing method.

The aperture 105 further comprises a step 115 disposed on the floor 110. The step 115 may be produced, for example, using the turbine component coating processes disclosed herein. However, it should also be appreciated that the step 115, the fluid flow passage 104 and/or the aperture 105 may additionally or alternatively be produced using any other suitable method such as, for example, additive manufacturing, casting, water-jet machining, electrical discharge machining, welding, or one or more other coating processes or combinations thereof. As best illustrated in FIG. 4, the step 115 comprises any additional material that breaks up the otherwise planer floor 110 such that exiting fluid flow 109 passing over the floor 110 is potentially impinged and/or stagnated at the step 115 which may cause some of the exiting fluid flow 109 to more evenly distribute across the span of the aperture 105 and/or become turbulated. Such distribution and/or turbulation may encourage the exiting fluid flow 109 to spread out along the surface 103 and/or remain proximal to the surface 103 for a longer period of time than if no distribution and/or turbulation occurred. This, in turn, may promote cooling of the surface 103 and the overall turbine component 100.

Specifically, the step 115 may be disposed between an inner portion 111 of the floor 110 and an outer portion 112 of the floor 110 such that the inner portion 111 and the outer portion 112 do not comprise a single planar surface. In some embodiments, the step 115 may comprise bump, ridge, plane or the like. The step 115 may meet with the inner and outer portions 111 and 112 at distinct points, or may meet at curved radii.

In some particular embodiments, the step 115 may extend for an entire length L between two opposing side walls 117. In other embodiments, the step 115 may extend for only a portion of the length L between two opposing side walls 117. In even some embodiments, the step 115 may comprise one or more gaps along its length. Moreover, in some embodiments, the step 115 may extend in a direction substantially perpendicular to the direction of fluid flow 109 (as illustrated in FIG. 5). In other embodiments, the step 115 may extend in a direction that is within about 30°, or even within about 45°, of the direction substantially perpendicular to the direction of fluid flow 109. In even some embodiments, the step 115 may extend in a non-linear configuration such as a jagged configuration, serpentine configuration, chevron configuration or the like. In some embodiments, the step 115 may extend up one or more side walls 117 of the aperture 105.

As best illustrated in FIG. 4, the step 115 may define a height H as it transitions from the inner portion 111 to the outer portion 112 of the floor. In some embodiments, the height H of the step 115 may be uniform along its entire length. In other embodiments, the height H may be non-uniform along its length. For example, the height H may vary such that the step 115 has various bumps or ridges along its length. In some embodiments, the height H of the step 115 may be based at least in part on the size and configuration of the fluid flow passage 104. For example, the height H may comprise from about 1 to about 0.1 times the size of the diameter D of the fluid flow passage 104, from about 1 to about 0.3 times the size of the diameter D of the fluid flow passage 104, or even from about 1 to about 0.5 times the size of the diameter D of the fluid flow passage 104. In some embodiments, the height H may comprise from about 0.5 to about 0.75 times the size of the diameter D of the fluid flow passage 104.

While the step 115 may be utilized in a variety of aperture 105 and fluid flow passage 104 configurations, the step 115 may be particularly suited for diffuser configurations. For example, in some embodiments, such as that illustrated in FIG. 5, the aperture 105 may comprise a diffuser configuration wherein the side walls 117 extend away from the fluid flow at a diffuser angle Θ. In such embodiments, Θ may be greater than 0° such as at least 5°, at least 10°, at least 20°, or even at least 30°.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A turbine component coating process, comprising:
applying a malleable masking material to one or more apertures of one or more fluid flow passages within a turbine component surface; then
applying a first coating over the malleable masking material and on the turbine component surface; then
locally applying a local masking material to the one or more apertures of the one or more fluid flow passages; and then
applying a second coating over the local masking material and on the first coating.

2. The turbine component coating process of claim 1, wherein applying the malleable masking material to fluid flow passages comprises applying the malleable masking material to a broad area of the turbine component surface comprising at least one of the one or more apertures of the one or more fluid flow passages.

3. The turbine component coating process of claim 2, wherein applying the malleable masking material is performed by roller application

4. The turbine component coating process of claim 2, further comprising removing the malleable masking material disposed on the turbine component surface outside of the one or more apertures of the one or more fluid flow passages.

5. The turbine component coating process of claim 4, wherein removing the malleable masking material disposed on the turbine component surface outside of the one or more apertures of the one or more fluid flow passages is performed by grit blasting.

6. The turbine component coating process of claim 5, wherein the grit blasting also at least partially pushes at least a portion of the malleable masking material further into at least one of the one or more apertures of the one or more fluid flow passages.

7. The turbine component coating process of claim 1, wherein the malleable masking material comprises a silicone elastomer.

8. The turbine component coating process of claim 1, wherein the first coating is applied through a kinetic energy process.

9. The turbine component coating process of claim 1, wherein the malleable masking material causes at least a portion of the first coating to form a step in at least one of the one or more apertures of the one or more fluid flow passages.

10. The turbine component coating process of claim 1, wherein locally applying the local masking material to the one or more apertures of the one or more fluid flow passages is achieved via a syringe.

11. The turbine component coating process of claim 1, wherein the local masking material comprises an ultraviolet curable material

12. The turbine component coating process of claim 1, wherein the local masking material comprises an electron beam curable material.

13. The turbine component coating process of claim 1, wherein the first coating is applied through high velocity oxygen fuel and the second coating is applied through air plasma spray.

14. The turbine component coating process of claim 1, further comprising removing the malleable masking material and the local masking material by a heating operation.

15. The turbine component coating process of claim 1, wherein the turbine component comprises a nickel-based or cobalt-based superalloy.

16. The turbine component coating process of claim 1, wherein the turbine component comprises a nozzle.

17. A turbine component coating process, comprising:
applying a malleable masking material to one or more apertures of one or more fluid flow passages within a turbine component surface, wherein at least a portion of the malleable masking material is pushed into the one or more apertures below the turbine component surface; then
applying a first coating over the masking material and on the turbine component surface, wherein the portion of malleable masking material pushed into the one or more apertures causes at least a portion of the first coating to form a step on a floor of the one or more apertures; then
locally applying a local masking material to the one or more apertures; and then
applying a second coating over the local masking material and on the first coating.

18. The turbine component coating process of claim 17, wherein the portion of malleable masking material pushed into the one or more apertures is at least partially pushed into said one or more apertures during grit blasting.

19. The turbine component coating process of claim 17, wherein the malleable masking material comprises a silicone elastomer.

20. The turbine component of claim 19, wherein the local masking material is locally applied via a syringe.
